(19) United States
(12) Patent Application Publication
(10) Pub. No.: US 2009/0142549 A1
(43) Pub. Date: Jun. 4, 2009

(54) FASTENED CONNECTIONS FOR LAMINATE TOOLING

(75) Inventors: Mark Manuel, Myrtle Beach, SC (US); Matthew T. Lowney, Davisburg, MI (US)

Correspondence Address: BROOKS KUSHMAN P.C., 1000 TOWN CENTER, TWENTY-SECOND FLOOR, SOUTHFIELD, MI, 48075, US

(73) Assignee: FloodCooling Technologies, L.L.C., Bloomfield Hills, MI (US)

(21) Appl. No.: 11/948,488

(22) Filed: Nov. 30, 2007

(51) Int. Cl. B32B 3/10; B29C 65/00

(52) U.S. Cl. 428/137; 156/250

(57) ABSTRACT

A tool for forming an article in a forming operation is provided with a plurality of individually formed laminate sheets that are aligned, stacked and assembled to collectively form a tool body, each having a coefficient of thermal expansion. A series of the laminate sheets has a plurality of apertures coaxially formed therethrough. A plurality of pins collectively have a coefficient of thermal expansion and sized to be received within the plurality of apertures the plurality of pins extending through at least a plurality of the laminate sheets and collectively extend through the series of the laminate sheets. The coefficient of thermal expansion of the pins is higher than the coefficient of thermal expansion of the laminate sheets such that the laminate sheets and pins expand to secure the pins within the apertures to maintain the laminate sheets in stacked alignment while being heated to form the tool.

### BACKGROUND OF THE INVENTION

1. Technical Field

The invention relates to laminate tools for molding articles.

2. Background Art

Various tools are conventionally utilized for forming articles using various forming processes, such as injection molding, blow molding, reaction injection molding, die casting, stamping and the like. These tools often utilize a first mold half and a second mold half, each having opposing forming surfaces for collectively forming an article therebetween. The mold halves are often formed separately, and one half translates relative to the other for closing, forming the article, opening, removing the article and repeating these steps.

Often, mold halves are each formed from a solid block of material that is capable of withstanding the stresses, pressures, impacts and other fatigue associated with the forming processes. The mold halves can be formed from laminate sheets.

### SUMMARY OF THE INVENTION

A first embodiment provides a tool for forming an article in a forming operation. The tool has a plurality of individually formed laminate sheets that are aligned, stacked and assembled to collectively form a tool body, each having a coefficient of thermal expansion. A series of the laminate sheets has a plurality of apertures coaxially formed therethrough. A plurality of pins collectively have a coefficient of thermal expansion and sized to be received within the plurality of apertures the plurality of pins extending through at least a plurality of the laminate sheets and collectively extend through the series of the laminate sheets. The coefficient of thermal expansion of the pins is higher than the coefficient of thermal expansion of the laminate sheets such that the laminate sheets and pins expand to secure each of the pins within each of the apertures to maintain the laminate sheets in stacked alignment after being heated to form the tool.

Another embodiment provides a method for assembling a tool for forming an article in a forming operation. The method comprises forming a first laminate sheet with a profile to define a first portion of a tool body. A first aperture is formed in the first laminate sheet. A second laminate sheet is formed with a profile to define a second portion of the tool body. A second aperture is formed in the second laminate sheet aligned with the first aperture in the first laminate sheet. The first and second laminate sheets are stacked in alignment to collectively provide at least a portion of the tool body. A first pin is inserted into the first laminate sheet first aperture and the second laminate sheet second aperture. The first and second laminate sheets and the first pin are heated such that the first pin expands at a first coefficient of thermal expansion and the first and second laminate sheets expand at a second coefficient of thermal expansion. The first coefficient of thermal expansion being greater than the second coefficient of thermal expansion such that the first pin maintains the first and second laminate sheets in stacked alignment while being heated to form the tool.

In still another embodiment, a tool for forming an article in a forming operation is disclosed. The tool is formed by a method comprising forming a first laminate sheet with a profile to define a first portion of a tool body. A first aperture is formed in the first laminate sheet. A second laminate sheet is formed with a profile to define a second portion of the tool body. A second aperture is formed in the second laminate sheet aligned with the first aperture in the first laminate sheet. The first and second laminate sheets are stacked in alignment to collectively provide at least a portion of the tool body. A first pin is inserted into the first laminate sheet first aperture and the second laminate sheet second aperture. The first and second laminate sheets and the first pin are heated such that the first pin expands at a first coefficient of thermal expansion and the first and second laminate sheets expand at a second coefficient of thermal expansion. The first coefficient of thermal expansion being greater than the second coefficient of thermal expansion such that the first pin maintains the first and second laminate sheets in stacked alignment while being heated to form the tool.

In yet another embodiment, a tool for forming an article in a forming operation is provided. The tool has N number of individually formed laminate sheets that are aligned, stacked and assembled to collectively form a tool body for forming an article in a forming operation and collectively having a laminate sheet expansion rate. A series of the N number of laminate sheets has a plurality of apertures coaxially formed therethrough. The tool has a plurality of pins collectively having a pin expansion rate and sized to be received within the plurality of apertures. The plurality of pins extend through at least a plurality of N number of the laminate sheets and collectively extend through the series of the laminate sheets. The pin expansion rate is higher than the laminate sheet expansion rate such that the N number of laminate sheets and the plurality of pins secures each of the pins within each of the apertures to maintain the N number of laminate sheets in stacked alignment while being heated to form the tool.

### BRIEF DESCRIPTION OF THE DRAWINGS

FIG. 1 is a perspective view of a tool in accordance with the present invention;

FIG. 2 is a front elevation view of a part of the tool of FIG. 1;

FIG. 3 is a partial section view of a portion of the tool of FIG. 1;

FIG. 4 is a partial section view of a portion of the tool of FIG. 1 according to one embodiment;

FIG. 5 is a partial section view of a portion of the tool of FIG. 1 according to another embodiment; and

FIG. 6 is a flow chart for a method for manufacturing a tool in accordance with the present invention.

### DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

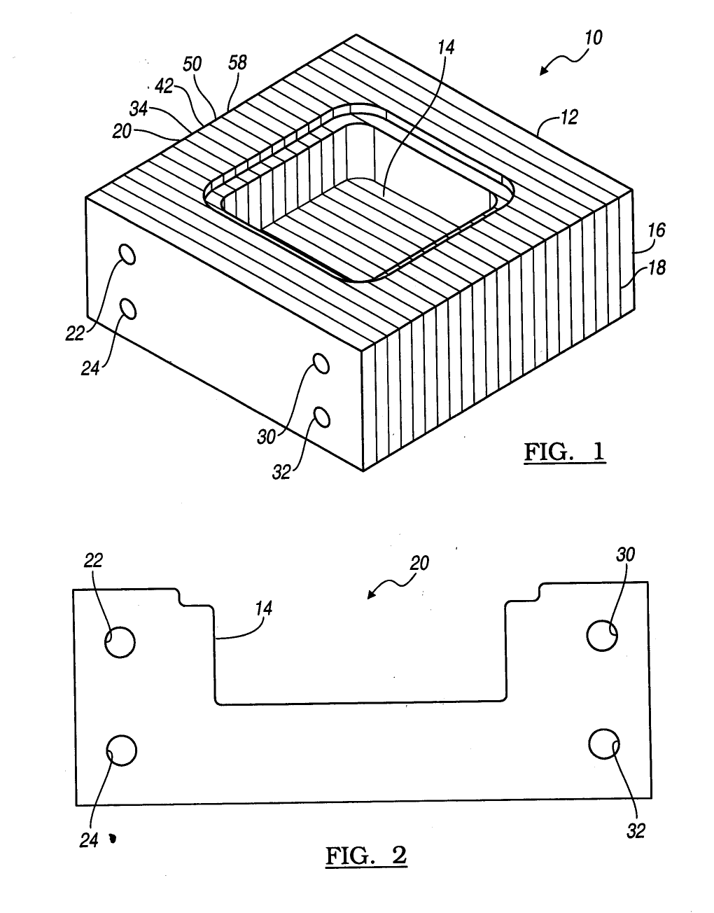

With reference now to FIG. 1, a tool is illustrated and is referenced generally by numeral 10. The tool 10 is a tool for forming an article in a molding operation, such as in injection molding, blow molding, reaction injection molding, roto-molding, die casting, stamping or the like. Alternatively, the tool 10 may be a mandrel that is shaped similar to the article for forming a molding tool, a die casting tool, a stamping tool, or the like, which is not employed for forming the article. Although one tool 10 is illustrated, the invention contemplates that the tool 10 may be a mold member, which is utilized in combination with one or more mold members, such as an opposed mold half for forming an article collectively therebetween.

The tool 10 includes a tool body 12, which has a forming surface 14 for forming the article. The tool body 12 is formed from a multiple layer process, for example, a laminate process, such as that disclosed in U.S. Pat. No. 6,587,742 B2, which issued on Jul. 1, 2003 to Manuel et al.; U.S. Pat. No. 5,031,483, which issued on Jul. 16, 1991 to Weaver; and U.S. Pat. No. 7,021,523 B2, which issued on Apr. 4, 2006 to Manuel; the disclosures of which are incorporated in their entirety by reference herein.

As illustrated, the tool body 12 is provided by a series of laminate sheets or plates 16. As discussed in the incorporated references, each of the laminate sheets 16 may be formed individually from a stock material by a cutting operation that cuts each laminate sheet 16 to a predetermined size such that the series of laminate sheets 16 provide a portion of the tool body 12, or provide the entire tool body 12 as illustrated in the embodiment of FIG. 1. In one embodiment, each of the laminate sheets 16 is cut by a laser for providing a near net shape of the tool body 12 and the forming surface 14, such that minimal machining is required once the laminate sheets 16 are assembled. After each of the laminate sheets 16 are cut, the sheets 16 are stacked, aligned, and assembled.

As disclosed in the incorporated references, the laminate sheets 16 may be assembled in multiple ways to achieve the desired characteristics of the tool body 12 for providing the forming operation. For example, the laminate sheets 16 may be bonded together by a bonding agent 18 displaced between adjacent sheets. The bonding agent 18 may be an adhesive or a brazing material. For example, if the laminate sheets 16 are each formed of a structural metal, such as stainless steel or aluminum, a brazing material 18, such as a copper sheet or an aluminum sheet, may be displaced between sequential laminate sheets 16, and the tool body 12 may be heated to assemble the adjacent sheets 16 into the collective tool body 12. Alternatively, the brazing material 18 may be displaced adjacent to the tool body 12, and then the tool body 12 and brazing material 18 may be heated until the brazing material 18 wicks between adjacent sheets 16 via capillary action. The tool body 12 is then cooled such that the brazing material 18 bonds the adjacent sheets 16. Alternatively, the brazing material 18 may be cast into the tool body 12 and the brazing material 18 may be conveyed to the gaps between sheets 16.

As laminate tools, such as the laminate tool 10, are assembled by utilization of a bonding agent, brazing operation, or casting operation, fasteners are often employed for maintaining the laminate sheets 16 in stacked alignment to avoid misalignment of the laminate sheets 16. For example, apertures 22, 24, 30 and 32 may be formed lengthwise through the laminate sheets 16 and fasteners may be disposed through the apertures. The apertures 22, 24, 30 and 32 are formed in non-critical areas of the laminate tool 10 to keep structural integrity of the laminate tool 10. Alternatively, stamped projections may be formed through the individual laminate sheets for securing the adjacent laminate sheets 16 together, such as that disclosed in U.S. Published Patent Application 2005/0196232 A1, which published on Sep. 8, 2005 to Manuel, which is incorporated in its entirety by reference herein. Alternatively, the adjacent laminate sheets 16 may be bonded together by a welding operation or by welded fasteners, such as that disclosed in U.S. Published Patent Application 2007/0039153 A1, which published on Feb. 22, 2007 to Manuel, which is incorporated in its entirety by reference herein.

Lengthwise fasteners and sequential interlocking stamped projections are limited in applicability because the cumulative friction of these friction fasteners and the cumulative force along the length is limited and may lead to breaking, warping, misalignment or the like under extreme loading conditions, such as extreme temperatures during brazing or casting or extreme mechanical loads applied during these processes. The stacking of welded fasteners also provides cumulative friction and forces that may lead to breaking, warpage, misalignment or the like.

The loads experienced by the individual laminate sheets 16 of the tool body 12 can be distributed amongst the individual laminate sheets 16 by an array of fasteners interconnecting the laminate sheets 16.

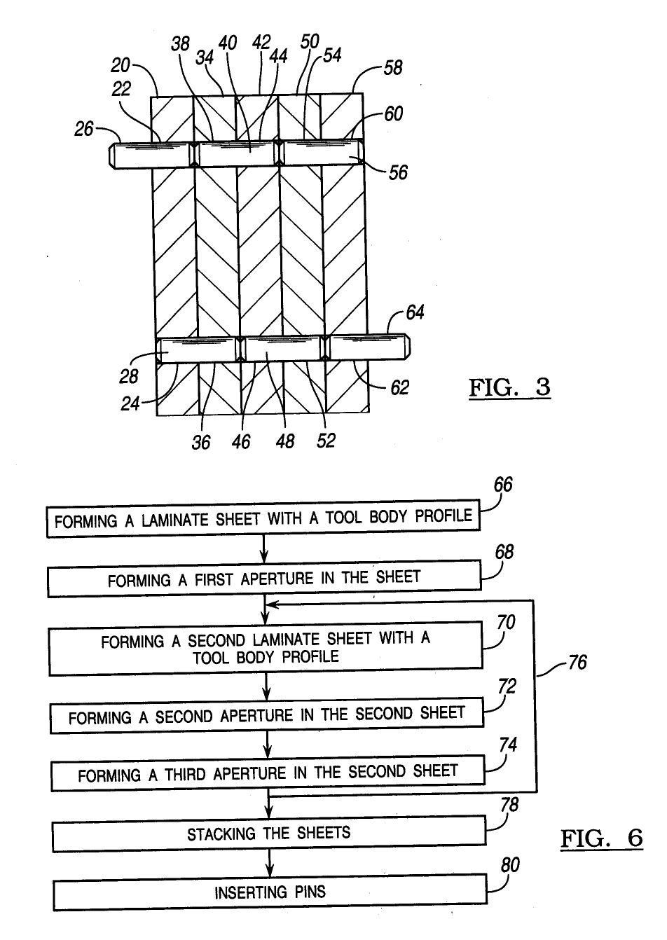

Referring now to FIG. 2, one arrangement of fastener arrays is illustrated with reference to a first laminate sheet or plate 20 of the series of laminate sheets 16. The first laminate sheet 20 is illustrated with an overall profile for providing a portion of the tool body 12, including a portion of the forming surface 14. The first laminate sheet 20 includes a pair of apertures 22, 24 for fastening the first laminate sheet 20 with adjacent laminate sheets in the series of laminate sheets 16. The first pair of apertures 22, 24 are provided for cooperating with a pair of fasteners, such as dowel pins 26, 28, as illustrated in FIGS. 3-5.

The dowel pins 26, 28 may be formed from a material having a higher expansion rate than an expansion rate of the first laminate sheet 20 and other subsequent laminate sheets. For example, the dowel pins 26, 28 may be made out of nickel or steel. When the dowel pins 26, 28 have a higher expansion rate than the first laminate sheet 20 and other subsequent laminate sheets, heating the dowel pins 26, 28 and the first laminate sheet 20 causes the dowel pins 26, 28 to expand at a faster rate than the first laminate sheet 20 to secure the first laminate sheet 20 and other subsequent laminate sheets together during brazing to maintain alignment.

Any array of apertures is formed through one of the laminate sheets such as the first laminate sheet 20. As illustrated in FIG. 2, the first laminate sheet may include more than just a pair of apertures 22, 24. For example, the first laminate sheet 20 may include another pair of apertures 30, 32, which cooperate with a second pair of fasteners. In another embodiment, six apertures may be employed. When a larger tool 10 is utilized, a greater amount of apertures are generally desired to facilitate alignment of the laminate sheets during the brazing process.

In one embodiment, to distribute the loading of the fastened connections, the apertures 22, 24, 30 and 32 are sized for press-fit engagement with a dowel pin. Thus, the apertures 22, 24, 30 and 32 are slightly undersized relative to the dowel pin such that an interference fit is provided, thereby securing the pin to the first laminate sheet 20 once the pin is inserted or pressed into one of the apertures 22, 24, 30 and 32. In another embodiment, the apertures 22, 24, 30 and 32 are sized to receive a pin in a slip fit engagement so that the apertures 22, 24, 30 and 32 are slightly oversized relative to the pin.

Referring now to FIG. 3, a pattern of staggered fasteners may be provided throughout the series of laminate sheets 16, for distributing the load imparted upon the laminate sheet 16. A second laminate sheet 34 is provided adjacent to the first laminate sheet 20. The second laminate sheet 34 is provided with a first aperture 36 formed therethrough, coaxial with the first sheet first aperture 24 for receiving the second pin 28 therein for fastening first sheet 20 and second sheet 34 together in stacked alignment for subsequent bonding.

The second laminate sheet 34 further includes a second aperture 38 formed therethrough for receiving a third pin 40. The second sheet second aperture 38 may be aligned coaxially with the second aperture 22 of the first sheet 20 for simplicity and design, assembly and uniform distribution of loading.

In continuation of the pattern, a third laminate sheet 42 is provided with a first aperture 44 coaxial with the second sheet second aperture 38 for receiving the third pin 40, thereby fastening the third sheet 42 to the second sheet 34. The third sheet 42 also includes a fourth aperture 46 for receipt of a fourth pin 48. A fourth laminate sheet 50 is provided with a first aperture 52 for receipt of the fourth pin 48 thereby securing the fourth sheet 50 to the third sheet 42.

The fourth sheet 50 also includes a second aperture 54 for receipt of a fifth pin 56. In further continuation of the pattern, a fifth sheet 58 is provided with a first aperture 60, which receives the fifth pin 56 for securing the fifth sheet 58 to the fourth sheet 50. The fifth sheet 58 also includes a second aperture 62, which receives a sixth pin 64 for securing the fifth sheet 58 to an adjacent sheet in the series of sheets 16.

The staggered arrangement of the fasteners to the laminate sheets 16 maintains the stacked alignment of the sheet 16 during the heating and bonding operation, such as brazing or casting within a furnace for reducing the cumulative friction in forces applied to the fasteners and to laminate sheets 16 for adequately distributing the load for reducing failure of the fasteners, or misalignement of the laminate sheets 16. Once bonded, the tool body 12 is at a near net shape, which may be machined or otherwise finished if a higher tolerance is desired.

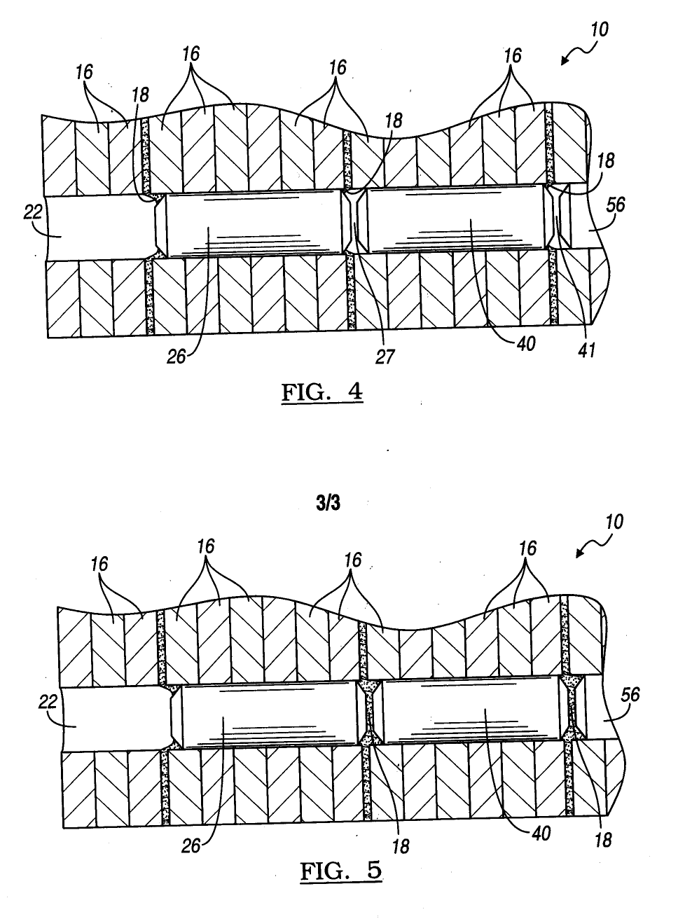

Referring now to FIG. 4, a portion of the laminate tool 10 of FIG. 1 is illustrated. A first dowel pin 26, a second dowel pin 40 and a portion of a third dowel pin 56 are shown holding together multiple laminate sheets 16 through a general aperture 22 formed through each of the multiple sheets 16. In one embodiment, the multiple sheets 16 are made out of stainless steel and the pins are steel dowel pins 26, 40 and 56, which may not require press fit engagements. In one embodiment, the steel dowel pins 26, 40 and 56 have a diameter of a quarter of an inch and a length not longer than three quarters of an inch while each of the multiple sheets 16 having a thickness of one tenth of an inch. While heating the tool 10, the dowel pins 26, 40 and 56 expand at a higher rate than the laminate sheets 16 to hold the laminate sheets 16 together. The dowel pins 26, 40 and 56 may have a coefficient of thermal expansion at least 1.2 times greater than the coefficient of thermal expansion for the multiple sheets 16. For example, the steel dowel pins 26, 40 and 56 may have a coefficient of thermal expansion of 6.78 μin/in-° F. while the multiple sheets 16 have a coefficient of thermal expansion of 5.5 μin/in-° F. The higher coefficient of thermal expansion for the dowel pins 26, 40 and 56 allows the dowel pins 26, 40 and 56 to expand at a faster rate than the multiple sheets 16.

The tool 10 may have a brazing material 18 that can be introduced in a brazing operation, to facilitate continued alignment of the laminate sheets 16 of the tool. As illustrated, the first and second dowel pins 26 and 40 have a gap 27 therebetween and the second and third dowel pins 40 and 56 have a gap 41. The gaps 27 and 41 avoid interference by the expanding dowel pins 40 and 56 since the dowel pins 40 and 56 expand at a faster rate than the laminate sheets 16 when heated to form at least a portion of a tool. The gaps 27 and 41 may exist between corresponding dowel pins 16 and 40, and 40 and 56 even after the heating and brazing operation. After the brazing operation, between each of the laminate sheets 16, a braze thickness per plate may be 0.0008 of an inch.

Referring now to FIG. 5, a portion of another embodiment of the laminate tool 10 of FIG. 1 is illustrated. Multiple sheets 16 of the tool 10 are held together by dowel pins 26, 40 and 56, which have been inserted through a general aperture 22 formed through each of the multiple sheets 16. In one embodiment, the multiple sheets 16 are made out of stainless steel. The pins may be nickel dowel pins 26, 40 and 56, which may not require press fit engagements. The nickel dowel pins 26, 40 and 56 may have a diameter of 0.248 of an inch to fit in the aperture 22 with a diameter of 0.248 of an inch. In one embodiment, the nickel dowel pins 26, 40 and 56 have a length not longer than seven tenths of an inch and each of the multiple sheets 16 have a thickness of one-ninth of an inch. While heating the tool 10, the dowel pins 26, 40 and 56 expand at a higher rate than the laminate sheets 16 to hold the laminate sheets 16 together so that the diameter of each of the dowel pins 26, 40 and 56 is larger than the diameter of the aperture 22. The dowel pins 26, 40 and 56 may have a coefficient of thermal expansion at least 1.3 times greater than the coefficient of thermal expansion for the multiple sheets 16. For example, the nickel dowel pins 26, 40 and 56 may have a coefficient of thermal expansion of 7.39 μin/in-° F. while the multiple sheets 16 have a coefficient of thermal expansion of 5.5 μin/in-° F. The higher coefficient thermal expansion for the dowel pins 26, 40 and 56 allows the dowel pins 26, 40 and 56 to expand at a faster rate than the multiple sheets 16.

The tool 10 may have a brazing material 18 that can be introduced in a brazing operation, to facilitate continued alignment of the laminate sheets 16 of the tool and fill in any gaps which exist between the pins 26, 40 and 56. The gaps filled by the brazing material 18 exist to avoid interference by the expanding dowel pins 40 and 56 since the dowel pins 40 and 56 expand at a faster rate than the laminate sheets 16 when heated. After the brazing operation, between each of the laminate sheets 16, a braze thickness per plate may be 0.0006 of an inch.

Laminate tools, such as the tool 10 illustrated in FIG. 1, may be manufactured by forming each laminate sheet from a laminate sheet manufacturing process, such as cutting each of the series of sheets 16 by a laser or other suitable cutting instrument. Each sheet 16 is cut for defining the appropriate portion of the tool 10, including a portion of the forming surface 14 if applicable. During this forming operation, the apertures may also be cut into the sheet 16. For example, slip-fit and press-fit apertures for receipt of a dowel pin can be cut with adequate precision by a laser. Of course, any suitable apertures for receipt of a dowel may be utilized within the scope of the present invention. The steps are illustrated in FIG. 6, wherein a first laminate sheet is formed in step 66 with a first aperture as in step 68. A second sheet is formed in step 70 with a second aperture in step 72 and third aperture, if necessary, in step 74. Steps 70, 72 and 74 can be repeated as indicated by repeat line 76 until the total number of sheets are provided. The last sheet may omit step 74 if a third aperture is not required if there is no subsequent sheet.

Adjacent sheets are then stacked in alignment at step 78 and fastened together at step 80 by insertion of a dowel pin in a hole of one sheet, such as the first aperture 22 in the first sheet 20 and through other subsequent sheets and insertion of another dowel pin into the aperture 32 provided at an opposite corner. Additional sheets may then be added and dowel pins may then be inserted through apertures aligned with apertures 24, 30 of the first sheet. These steps are repeated, as illustrated in FIG. 3, until tool body 12 is built, stacked, aligned, and fastened in stacked alignment by the series of pins. Once the tool body 12 is built, the laminate sheets are bonded together, the tool body 12 is finished by machining, if necessary, and the tool 10 is utilized for manufacturing articles.

Of course, the invention contemplates utilizing other laminate tool features, such as heat transfer lines for heating or cooling the forming surface 14 and the article formed by the forming surface 14 in combination with the fastener arrangement disclosed herein.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tool for forming an article in a forming operation comprising:
a plurality of individually formed laminate sheets that are aligned, stacked and assembled to collectively form a tool body for forming an article in a forming operation and each having a coefficient of thermal expansion, wherein a series of the laminate sheets has a plurality of apertures coaxially formed therethrough; and
a plurality of pins collectively having a coefficient of thermal expansion and sized to be received within the plurality of apertures the plurality of pins extending through at least a plurality of the laminate sheets and collectively extending through the series of the laminate sheets;
wherein the coefficient of thermal expansion of the pins is higher than the coefficient of thermal expansion of the laminate sheets such that the laminate sheets and pins expand to secure each of the pins within each of the apertures to maintain the laminate sheets in stacked alignment while being heated to form the tool.

2. The tool of claim 1 wherein each of the plurality of apertures receives at least two pins of the plurality of pins such that the at least two pins have a gap therebetween before heating the laminate sheets and pins to accommodate varying thermal expansion rates of the pins and the laminate sheets.

3. The tool of claim 1 wherein the plurality of pins are received within the plurality of apertures in one of a slip-fit engagement and a press-fit engagement.

4. The tool of claim 1 wherein the plurality of apertures are further defined as:
a first pair of apertures provided proximate to a first and second non-critical area of the laminate sheets;
a second pair of apertures provided proximate a third and fourth non-critical area of the laminate sheets;
wherein the plurality of pins are provided within the first pair of apertures and the second pair of apertures.

5. The tool of claim 1 wherein the plurality of pins have a slip-fit engagement within the plurality of apertures.

6. The tool of claim 1 wherein the plurality of pins have a press-fit engagement within the plurality of apertures.

7. The tool of claim 1 wherein the plurality of pins further comprise a plurality of steel dowels having a diameter of twenty-five hundredths of an inch.

8. The tool of claim 1 wherein the plurality of pins further comprise a plurality of nickel dowels having a length not longer than seventy-five hundredths of an inch.

9. The tool of claim 1 wherein each of the plurality of apertures receives at least two pins of the plurality of pins such that the at least two pins have abutting ends.

10. A method for assembling a tool for forming an article in a forming operation comprising:
forming a first laminate sheet with a profile to define a first portion of a tool body;
forming a first aperture in the first laminate sheet;
forming a second laminate sheet with a profile to define a second portion of the tool body;
forming a second aperture in the second laminate sheet aligned with the first aperture in the first laminate sheet;
stacking the first and second laminate sheets in alignment to collectively provide at least a portion of the tool body;
inserting a first pin into the first laminate sheet first aperture and the second laminate sheet second aperture; and
heating the first and second laminate sheets and the first pin such that the first pin expands at a first coefficient of thermal expansion and the first and second laminate sheets expand at a second coefficient of thermal expansion, the first coefficient of thermal expansion being greater than the second coefficient of thermal expansion such that the first pin maintains the first and second laminate sheets in stacked alignment while being heated to form the tool.

11. The method of claim 10 further comprising brazing the first and second laminate sheets together to form the at least a portion of the tool body.

12. The method of claim 10 further comprising bonding the first and second laminate sheets together to form the at least a portion of the tool body.

13. The method of claim 10 further comprising forming an article from the tool body.

14. The method of claim 10 further comprising cutting the profile of at least one of the laminate sheets from a stock sheet with a laser.

15. The method of claim 10 further comprising cutting one of the first and second apertures through at least one of the laminate sheets with a laser.

16. The method of claim 10 further comprising pressing the first pin into the first laminate sheet first aperture.

17. The method of claim 10 further comprising pressing the second pin into the second laminate sheet second aperture.

18. The method of claim 10 further comprising:
forming a third aperture in the second laminate sheet;
forming a third laminate sheet with a profile to define a third portion of the tool body;
forming a fourth aperture in the third laminate sheet aligned with the third aperture in the second laminate sheet;
inserting a second pin into the second laminate sheet third aperture and the third laminate sheet fourth aperture; and
heating the first, second and third laminate sheets and the first and second pins such that the first and second pins each expand at a first coefficient of thermal expansion and the first, second and third laminate sheets expand at a second coefficient of thermal expansion, the first coefficient of thermal expansion being greater than the second coefficient of thermal expansion.

19. A tool for forming an article in a forming operation formed by a method for assembling the tool comprising:
forming a first laminate sheet with a profile to define a first portion of a tool body;
forming a first aperture in the first laminate sheet;
forming a second laminate sheet with a profile to define a second portion of the tool body;
forming a second aperture in the second laminate sheet aligned with the first aperture in the first laminate sheet;
stacking the first and second laminate sheets in alignment to collectively provide at least a portion of the tool body;
inserting a first pin into the first laminate sheet first aperture and the second laminate sheet second aperture; and
heating the first and second laminate sheets and the first pin such that the first pin expands at a first coefficient of thermal expansion and the first and second laminate sheets expand at a second coefficient of thermal expansion, the first coefficient of thermal expansion being greater than the second coefficient of thermal expansion such that the first pin maintains the first and second laminate sheets in stacked alignment while being heated to form the tool.

20. A tool for forming an article in a forming operation comprising:
N number of individually formed laminate sheets that are aligned, stacked and assembled to collectively form a tool body for forming an article in a forming operation and collectively having a laminate sheet expansion rate, wherein a series of the N number of laminate sheets has a plurality of apertures coaxially formed therethrough; and
a plurality of pins collectively having a pin expansion rate and sized to be received within the plurality of apertures the plurality of pins extending through at least a plurality of N number of the laminate sheets and collectively extending through the series of the laminate sheets;
wherein the pin expansion rate is higher than the laminate sheet expansion rate such that the N number of laminate sheets and the plurality of pins secures each of the pins within each of the apertures to maintain the N number of laminate sheets in stacked alignment while being heated to form the tool.
